(19) United States
(12) Patent Application Publication
(10) Pub. No.: US 2005/0238347 A1
(43) Pub. Date: Oct. 27, 2005

(54) Iris diaphragm, iris diaphragm driving device and camera unit having the same, and iris diaphragm control method

(75) Inventor: Eui-kuen Oh, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/067,901

(22) Filed: Mar. 1, 2005

(30) Foreign Application Priority Data
Apr. 23, 2004 (KR) 2004-28127

(51) Int. Cl. G03B 9/08

(52) U.S. Cl. 396/449

(57) ABSTRACT

An iris diaphragm includes at least one lens shutter to adjust the size of an aperture that incident light passes through according to movement of the at least one lens shutter. At least one ND filter is installed to move independently of the lens shutter to reduce the amount of incident light by covering the aperture stopped-down by the lens shutter according to the movement of the at least one ND filter.

### CROSS-REFERENCE TO RELATED APPLICATIONS

This application claims the benefit under 35 U.S.C. § 119(a) of Korean Patent Application No. 2004-28127 filed Apr. 23, 2004, in the Korean Intellectual Property Office, the entire disclosure of which is hereby incorporated by reference.

### BACKGROUND OF THE INVENTION

1. Field of the Invention

The present invention generally relates to an image photographing device for photographing and recording and storing image data. More particularly, the present invention relates to an iris diaphragm, an iris diaphragm driving device, and a camera unit having the same, and an iris diaphragm control method.

2. Description of the Related Art

Camcorders are one representative example of image data recording and reproducing devices, and are broadly used today for photographing moving images and still images. A camcorder includes a camera unit, a signal conversion unit, a deck for recording and reproducing photographed images, and a display unit. The camcorder usually uses a cassette tape as a recording medium to record photographed image data. Also, in recent years, a lot of attention has been focused on compact sized recording medium, such as a small-sized, and light-weight image recording and reproducing device using a hard disk drive. The small-sized and light-weight device was made possible because a deck is not included in the image recording and reproducing device using a hard disk drive.

The camera unit and a lens barrel, with a focusing lens module and a zoom lens, are packed in a module and are installed inside the main body of a product. The focusing lens and the zoom lens are driven by a motor that is installed in the lens barrel.

Also, the lens barrel includes a lens shutter for adjusting the amount of incident radiation. In effect, a plurality of motor-driven shutter members adjust the amount of incident light passing through the lens while moving.

According to the above configuration, besides the lens motor, a plurality of motors are arranged outside of the lens barrel. The motors are disadvantages for reducing the size of the camera unit.

Moreover, as the motor is mounted on the outer side of the cylindrical lens barrel, the lens barrel has the angular outer configuration only. Therefore, this limits the design of the lens barrel.

In the meantime, a Neutral Density (ND) filter is also housed in the lens barrel. The ND filter reduces the amount of incident light that passes through the lens, and suppresses an occurrence of diffraction where resolution is noticeably reduced at a high brightness level. As a result, resolution is much improved.

However, a problem arises because the ND filter is bonded or coupled to the lens shutter and moves with the lens shutter as one body. Therefore, irrespective of changes of the diaphragm of the lens or the openness of the lens shutter, a certain part of the light path is always blocked by the ND filter. Although this fact does not have a great impact on the resolution at high brightness, it greatly reduces resolution at low brightness so the amount of light passing through the lens is very low.

### SUMMARY OF THE INVENTION

Accordingly, it is a primary object of the present invention to provide an iris diaphragm with an improved structure where an ND filter and a lens shutter are operated independently.

It is another object of the present invention to provide an iris diaphragm driving device with an improved structure capable of driving an ND filter independently with respect to a lens shutter.

It is still another object of the present invention to provide a camera unit having an ND filter that operates independently of a lens shutter.

It is still another object of the present invention to provide an iris diaphragm control method for separately driving a lens shutter and an ND filter.

The above aspects and/or other features of the present invention may substantially be achieved by an iris diaphragm of image photographing equipment having at least one lens shutter formed on a light path to adjust the amount of incident light by opening and closing the light path according to movement thereof, and at least one ND filter independently movable with respect to the lens shutter to reduce the amount of incident light according to movement thereof on the light path that is opened by the lens shutter.

The lens shutter and the ND filter may be pivotally movable on the light path, respectively. The lens shutter and the ND filter may share a common center of rotation.

The ND filter operates such that a stop-down portion of the light path by the ND filter may be varied according to the movement of the ND filter. The stop-down portion may be inversely proportional to the openness of the light path.

An overlapped portion between the ND filter and the lens shutter may be varied according to the movement of the ND filter.

A plurality of ND filters may be provided, each moving independently of each other.

The ND filter may comprise a cam slit for pivoting movement. The cam slit may comprise a substantially linear shape.

The lens shutter may comprise a cam slit for pivoting movement.

The cam slit of the lens shutter and the cam slit of the ND filter may be overlapped with each other.

The overlapped portion between the cam slits may be inversely proportional to the openness of the light path.

A second object of the present invention may substantially be achieved by providing an iris diaphragm driving device for image photographing equipment having at least one lens shutter to open and close a light path. At least one ND filter moves independently of the lens shutter to reduce the amount of incident light passing through the light path. A driving unit drives the lens shutter and the ND filter.

The driving unit may include a motor housing to support the ND filter and to provide the light path. A stator assembly is installed inside the motor housing. A rotor is rotatably installed inside the stator assembly, and causes the ND filter to pivot in accordance with the rotation thereof.

The ND filter may be pivotally movable in the motor housing and is positioned on the light path according to the pivoting movement of the ND filter.

The rotor may include a driving pin to transfer the movement of the rotor to the pivoting movement of the ND filter.

The motor housing may include an axis boss for supporting the ND filter to pivot thereon, and a guide to guide the motion of the driving pin.

The ND filter may have a cam slit that is shaped to engage the driving pin.

The cam slit may have a substantially linear shape.

The lens shutter may be supported by the motor housing so that the lens shutter and the ND filter share a common center of rotation.

The ND filter and the lens shutter may respectively have an axis hole supported by the motor housing and a cam slit interoperable by the driving pin.

The cam slit of the ND filter and the cam slit of the lens shutter may have different shapes. The cam slit of the ND filter and the cam slit of the lens may be partially overlapped according to the pivoting movement of the ND filter and the lens shutter.

A plurality of lens shutters and a plurality of ND filters may be provided.

The above objects may also be substantially achieved by providing a camera unit having a lens barrel, a zoom lens module housed in the lens barrel, and a focusing lens module housed in the lens barrel. At least one lens shutter is movably installed between the zoom lens module and the focusing lens module to adjust an aperture that light passes through. An ND filter is movably installed inside the lens barrel to reduce the amount of incident light by covering the aperture that is stopped down by the lens shutter. A driving unit is installed inside the lens barrel to drive the lens shutter and the ND filter.

The driving unit may include a motor housing installed inside the lens barrel to support the pivoting movement of the lens shutter and the ND filter. A stator assembly is installed inside the motor housing. A rotor is rotatably installed inside the stator assembly to pivot the lens shutter and the ND filter according to rotation of the rotor.

The above objects may also be substantially achieved by providing a method of controlling an iris diaphragm by first moving at least one lens shutter to stop down an aperture that incident light passes through. Second, at least one ND filter is moved to cover the stop-down aperture and thus, to reduce the amount of incident light, wherein the decrement of the incident light is fixed or varied according to a change of the aperture size.

The first and second steps may be carried out at the same time.

The first step may include a sub-step for moving the lens shutter to reduce the amount of incident light. The second step may include a sub-step for increasing the decrement of incident light inversely proportional to the third step.

The variable amount of incident light in the first step may be inversely proportional to the decrement of incident light in the second step.

Other objects, advantages and salient features of the invention will become apparent from the following detailed description, which, taken in conjunction with the annexed drawings, discloses preferred embodiments of the invention.

### BRIEF DESCRIPTION OF THE DRAWINGS

The above aspects and features of the present invention are more apparent by describing certain embodiments of the present invention with reference to the accompanying drawings, in which:

FIG. 1 is a schematic cross-sectional view of a camera unit according to one embodiment of the present invention;

FIG. 2 is an exploded perspective view of an iris diaphragm driving device of FIG. 1;

FIG. 3 is a cross-sectional view of an iris diaphragm driving device of FIG. 2;

FIG. 4 is a plan view of an iris diaphragm of FIG. 3 connected to a driving unit;

FIG. 5A and FIG. 5B respectively show a perspective view of a rotor of FIG. 2 connected to a stator assembly;

FIG. 6A and FIG. 6B respectively show a perspective view of an iris diaphragm driving device of FIG. 2 before an iris diaphragm is assembled thereto;

FIG. 7 is a perspective view of a completely assembled iris diaphragm driving device of FIG. 2;

FIG. 8A and FIG. 8B respectively show a plan view of an iris diaphragm of FIG. 4 during operation;

FIG. 9 and FIG. 10 are schematic plan views of an iris diaphragm driving device according to another embodiment of the present invention;

FIGS. 11 to 13 respectively show schematic plan views of the operation of an iris diaphragm driving device according to another embodiment of the present invention.

Throughout the drawings, like reference numbers should be understood to refer to like elements, features and structures.

### DETAILED DESCRIPTION OF EXEMPLARY EMBODIMENTS

Certain embodiments of the present invention are described in greater detail with reference to the accompanying drawings.

The matters defined in the description, such as a detailed construction and elements thereof, are provided to assist in a comprehensive understanding of the invention. Thus, it is apparent that various changes and modifications may be made to the examples provided herein without departing from the spirit and scope of the present invention. Also, descriptions of well-known functions and elements are not described in detail for conciseness and clarity.

An iris diaphragm, an iris diaphragm driving device, a camera unit and an iris diaphragm control method in accordance with exemplary embodiments of the present invention are described in detail with reference to the accompanying drawings.

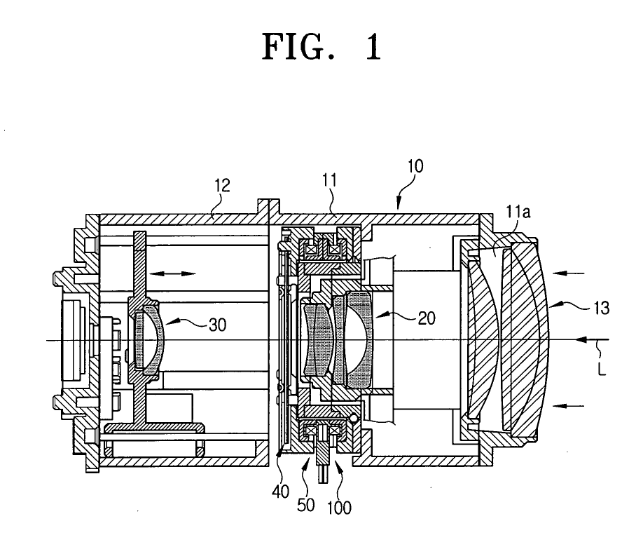

Referring to FIG. 1, the camera unit according to one embodiment of the present invention includes a lens barrel 10, a zoom lens module 20 and a focusing lens module 30 housed in the lens barrel 10, an iris diaphragm 40 (hereinafter, referred to as an iris diaphragm unit), and a driving unit 50 for driving the diaphragm unit 40.

The lens barrel 10 has a substantially cylindrical shape and a pair of connected lens barrels 11, 12. An object lens module 13 is disposed at the front end of an entrance 11a of the first lens barrel 11, and a substrate having a CCD (“charge coupled device”) module is disposed at the rear end of the second lens barrel 12.

The zoom lens module 20 is movably installed in the lens barrel 10. That is, the zoom lens module moves by help of a transfer means (not shown) back and forth for a predetermined distance inside the second lens barrel 12 in a direction substantially parallel to incident light L to zoom in and out on a subject.

The focusing lens module 30 is movably installed in the lens barrel 10. More specifically, the focusing lens module 30 is disposed beside the zoom lens module 20 to focus a subject. Similar to the zoom lens module 20, the focusing lens module 30 moves by help of a transfer means (not shown) back and forth for a predetermined distance inside the lens barrel 10 in a direction parallel to incident light L. The transfer means for moving each module 20, 30 is a conventional transfer implement. For example, a guide shaft is one option for supporting the modules 20, 30 in the lens barrel 10, and lead screws rotated by a motor may be used to selectively move the modules 20, 30. Since those skilled in the art are already familiar with the technique related to the transfer means for the modules 20, 30, no further detail is provided.

The diaphragm unit 40 is housed in the lens barrel 10. Preferably, the diaphragm is disposed between the modules 20, 30. The diaphragm unit 40 adjusts the amount of incident light to the lens barrel 10, and is installed in a direction substantially transveres to the direction of incident light. The diaphragm unit 40 is described in more detail below.

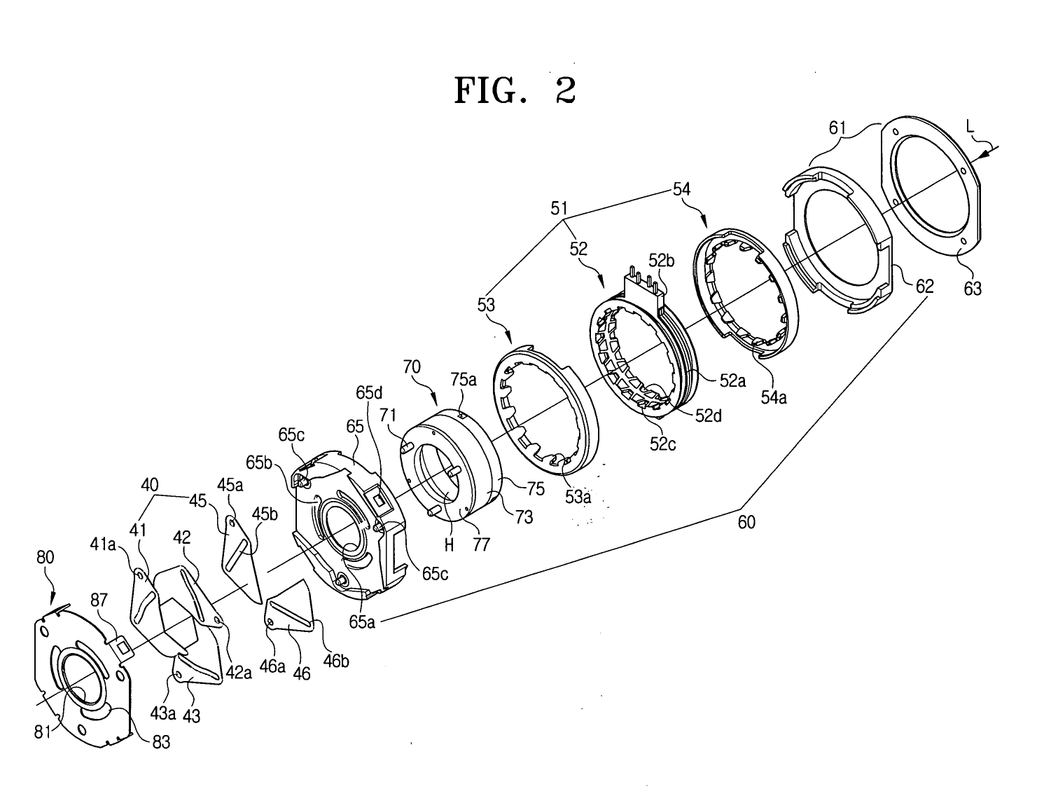

The driving unit 50 is housed in the lens barrel 10. Referring to FIG. 2, the driving unit 50 includes a stator assembly 51, a motor housing 60, and a rotor 70 disposed in the stator assembly 51.

The stator assembly 51 is supported inside the motor housing 60. The stator assembly 51 includes a ring-type bobbin 52, and first and second stator members 53, 54 connected to both sides of the bobbin 52.

A coil 52a is wound around the bobbin 52, and the coil 52a is electrically coupled to an external terminal through a terminal unit 52b disposed outside the bobbin 52. The first and second stator members 53, 54 are connected to both sides of the bobbin 52, respectively. Each of the stator members 53, 54 has fixed sectors 53a, 54a circumferentially spaced apart at regular intervals. The fixed sectors 53a, 54a are embedded along the inner circumference of the bobbin 52, and are geared with each other. Also, the sector-mounting grooves 52c, 52d are formed on the inner circumference of the bobbin 52. The grooves 52c, 52d are formed to cross each other. When an electrical signal is input to the coil 52a in a designated pattern, the fixed sectors 53a, 54a are magnetized according to the input pattern of the electrical signal. A magnetic force is generated between the magnetic fixed sectors 53a, 54a and the rotor 70. The magnetic force rotates the rotor 70 by a designated degree at a time.

The rotor 70 is rotatably installed inside the stator assembly 51. Incident light L passes through hole H formed at the center of the rotor 70, as shown in FIG. 2. Therefore, the rotor does not have a shaft disposed therein. A plurality of driving pins 71 geared with the diaphragm unit 40 protrude from one end of the rotor 70. In an exemplary embodiment of the present invention, three driving pins 71 are used that are spaced apart at regular intervals. However, as will be appreciated, any suitable number of driving pins may be used.

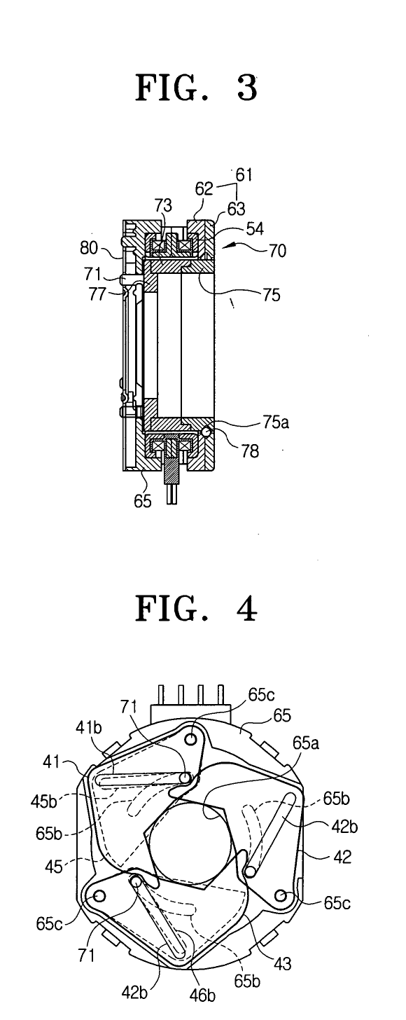

As shown in FIG. 3, the rotor 70 includes a substantially cylinder-shaped magnet 73, a sleeve tube 75 connected to one end of the magnet 73, and a plate 77 connected to the other end of the magnet 73. The N-pole and the S-pole of the magnet 73 are spaced apart in the rotational direction. The sleeve tube 75 has substantially the same cylindrical shape as the magnet 73 and is connected to one end of the magnet 73. A plurality of bearing mounting grooves 75a are formed on the outer circumference of the sleeve tube 75. The bearing 78 mounted in the grooves 75a is fitted inside the motor housing 60 and is supported thereby. The plate 77 has a donut shape and is connected to the other end of the magnet 73. The plate 77 is installed such that the driving pins 71 protrude therefrom. Through an insert molding method, the driving pins 71 may be directly inserted and molded to the plate 77 during the manufacturing process. The driving pins 71 are movably installed in the motor housing 60. The center of the rotor 70 is empty, and, as aforementioned, the rotor 70 is rotatably installed inside the stator assembly 51.

The magnet 73, the sleeve tube 75, and the plate 77 may be connected to each other as one body. The entire rotor 70 is made of magnetic materials and the driving pins 71 may be simultaneously connected thereto through the insert molding method.

The motor housing 60 is fixed inside the lens barrel 10. The motor housing 60 includes first and second housings 61, 65 that encompass the stator assembly 51.

The first housing 61 supports the bearing 78 of the rotor 70. More specifically, the first housing 61, as shown in FIGS. 2 and 3, covers the second stator member 54. Front and back brackets 62, 63 may be coupled to each other. Each bracket 62 or 63 may be separately manufactured and then coupled to the second stator member 54. Guide grooves may be formed on the borders of the brackets 62, 63 as a motion guide for the bearing 78. That is, when the rotor 70 rotates, the bearing 78 moves along the border of each bracket 62, 63 to support the rotor 70. Alternatively, the brackets 62, 63 may be formed as one body. The guide groove of the bearing 78 is formed on the inner circumference of the unitarily formed first housing.

The second housing 65 is connected to one side of the first housing 61. The other side of the first housing 61 is connected to the stator assembly 51 situated between the first and second housings 61, 65. An opening 65a is opened and closed by the diaphragm unit 40 and is formed at the center of the second housing 65. Also, the opening 65a is surrounded by a plurality of guide slits 65b for supporting the motion of the driving pins 71. Each guide slit 65b has a length corresponding to a rotational angle of the rotor 70. The driving pins 71 are supported while being inserted in the guide slits 65b, and the driving pins move along the guide slits 65b when the rotor 70 rotates.

The second housing 65 includes a plurality of bosses 65c. Each boss 65c is preferably located radially spaced from the opening 65a. Therefore, when the diaphragm unit 40 rotates by a small angle around the boss 65c, the aperture 65a may still be opened and closed.

The diaphragm unit 40 includes a plurality of lens shutters 41, 42, 43, and a plurality of ND (Neutral Density) filters 45, 46. The lens shutters 41, 42, 43 open or close an opening 65a of the first housing 65 to adjust the amount of incident light passing through the lens.

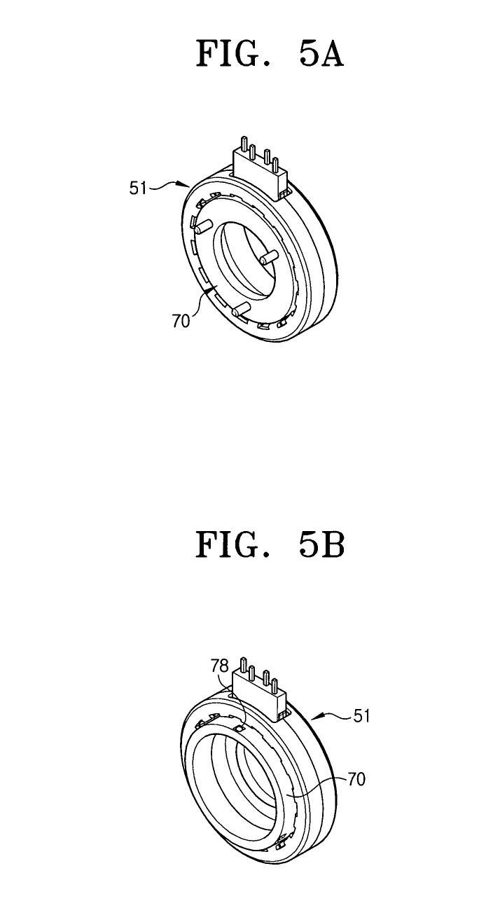

Referring to FIG. 4, the three lens shutters 41, 42, 43 respectively have holes 41a, 42a, 43a (refer to FIG. 2) adapted to receive the bosses 65c, and cam slits 41b, 42b, 43b adapted to receive the driving pins 71. The lens shutters 41, 42, 43 are substantially uniform in shape and size. Thus, when the driving pins 71 rotate along the cam slits 41b, 42b, 43b, the lens shutters 41, 42, 43 engaged with the driving pins rotate at the same time. As a result, the size of the opening 65a may be adjusted. Each of the cam slits 41b, 42b, 43b has a linear shape and a designated length.

Control of the rotational angle of the rotor 70 enables the linear cam slits 41b, 42b, 43b to adjust light passing through the lens shutter 40, namely the f number (f. no) of incident light.

The ND filters 45, 46 are rotatably installed in the first motor housing 65. According to rotational positions of the ND filters 45, 46, the amount of incident light passing through the opened light path by the lens shutters 41, 42, 43 may be reduced. Each of the ND filters 45, 46 has substantially the same shape. Moreover, the ND filters 45 and 46 respectively include holes 45a, 46a adapted to engage the bosses 65c, and cam slits 45b, 46b. The ND filters 45, 46 are installed such that the ND filters have the same center of rotation with respect to designated shutters 41, 42, respectively, out of lens shutters 41, 42, 43. Although certain areas of ND filters 45, 46 are overlapped with the lens shutters 41, 42, the ND filters and the lens shutters still move independently of each other. The driving pins 71 are engaged with the cam slits 45b, 46b. Accordingly, when the rotor 70 rotates, the cam slits 45b, 46b geared with the driving pins 71 rotate, and as a result, the ND filters 45, 46 also rotate. Thus, the ND filters open or close the opening 65a. The cam slits 45b, 46b have a linear shape, and each has a designated length. The rotation angle and speed of the ND filters 45, 46 following the motion of the driving pins 71 are determined by the shape and position of the cam slits 45b, 46b, similar to the lens shutters 41, 42, 43. For example, the cam slits 45b, 46b may be overlapped at least at one position. When the opening 65a is completely closed, the ND filter 45 is not needed. Therefore, when the opening 65a is completely closed, the two cam slits 45b, 46b are formed to be coincident with each other.

When the lens shutters 41, 42, 43 move to open the light path gradually, the ND filter 45 preferably rotates by a smaller amount than the lens shutters 41, 42, 43 to reduce the amount of incident light passing through the opened light path, thereby adjusting the resolution of the lens. The larger the light path, that is, the more opening 65a is opened, the less the cam slit 45b is overlapped with another cam slit 41b.

Additionally, the ND filters 45, 46 are installed such that their overlap with the lens shutters 41, 42 varies according to the rotational positions. The surface area of each ND filter 45, 46 has a different, smaller shape than the surface area of each lens shutter 41, 42.

The overlapping of the ND filter 45 and the lens shutter 41 is proportional to the openness of the opening 65a. That is, when the opening 65a is completely opened, the ND filter 45 is completely covered by the lens shutter 41 and is completely out of the opening 65a.

The two ND filters 45, 46 may have different light transmittances. Each ND filter 45, 46 may stop down or cover the same area of the aperture 65a, but have different light transmittances. Therefore, it becomes possible to more precisely adjust the amount of incident light according to how much the aperture 65a is opened.

Referring to FIG. 2, to prevent the diaphragm unit 40 from separating, a cover 80 is detachably connected to the second housing 65. The cover 80 has an opening 81 corresponding to the opening 65a. A slit 83 corresponding to a guide slit 65b is formed around the opening 81. A plurality of holes 85 in the second housing correspond to the bosses 65c. An elastic locking unit 87 formed around the cover 80 is interlocked to a combining unit 65d formed on the outer circumference wall of the first housing 65.

The following describes an assembling procedure of the iris diaphragm driving device including disposing the diaphragm unit 40 in the camera unit.

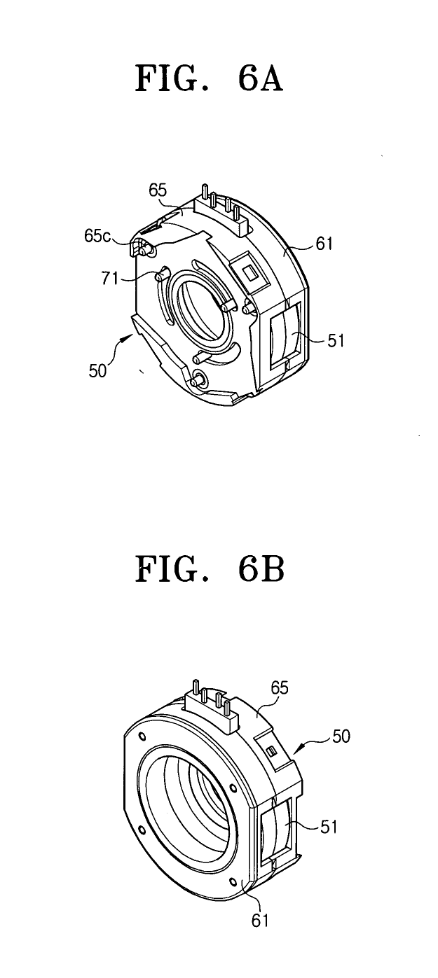

First, the stator assembly 51 of FIG. 2 is assembled. Then the stator assembly 51 and the rotor 70 are put together, as shown in FIGS. 5A and 5B.

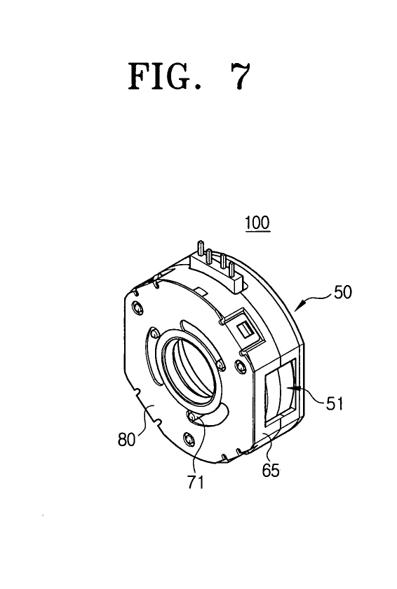

As shown in FIGS. 5A and 5B, the rotor 70 is disposed inside the stator assembly 51 but is not necessarily supported thereby. Thus, the first and second housings 61, 65 may encompass the stator assembly 51, respectively, as illustrated in FIGS. 6A and 6B. The driving pins 71 of the rotor 70 are inserted in the guide slits 65b of the second housing 65. The bearing 78 installed at the outer circumference of the rotor 70 is supported by the first housing 61. As shown in FIGS. 6A and 6B, after the driving unit 50 is assembled, the rotor 70 is rotatable along the guide slit 65b.

Following the assembly of the driving unit 50, the ND filters 45, 46 are inserted on the driving pins 71 and the bosses 65, respectively. Then the lens shutters 41, 42, 43 are assembled on the bosses 65c to overlap the ND filters 45, 46. Parts of the lens shutters 41, 42, 43 are overlapped with the ND filters 45, 46.

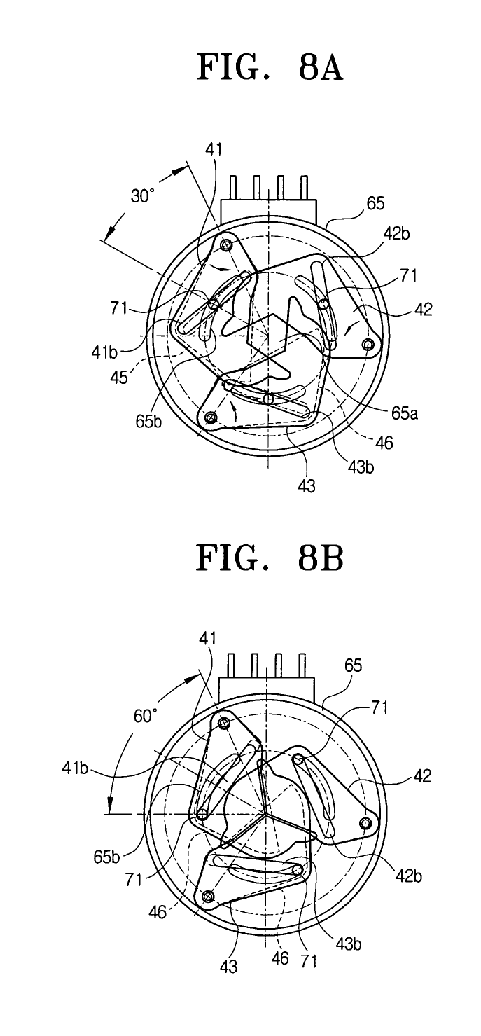

To prevent the separation of the lens shutters 41, 42, 43 and the ND filters 45, 46 assembled in the second housing 65, the cover 80, as shown in FIG. 7, is assembled in the second housing 65. Thus, the iris diaphragm driving device 100 assembly is completed.

As shown in FIG. 1, the assembled iris diaphragm driving device 100 is housed in the lens barrel 10. Other parts inside the lens barrel 10, namely the zoom lens module 20 and the focusing lens module 30, are assembled based on conventional procedures.

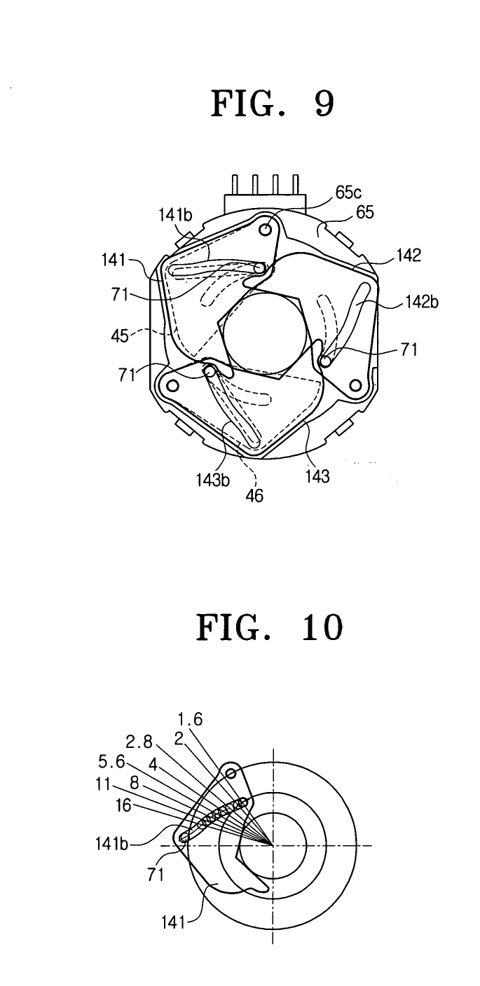

The opening and closing operation of the diaphragm unit 40 is explained below with reference to FIG. 4, FIG. 8A and FIG. 8B.

FIG. 4 depicts the completely opened diaphragm unit 40. That is, the lens shutters 41, 42, 43 and the ND filters 45, 46 do not overlap the opening 65a, but are set apart to the outside of the opening 65a. The ND filters 45, 46 are completely out of the range of the opening 65a, and thus, have no influence on the amount of incident light. More specifically, when the diaphragm unit 40 is completely opened, the ND filters 45, 46 are completely out of the light path so a deterioration of resolution does not occur.

When the rotor 70 rotates by a designated, angle as shown in FIG. 8A, the lens shutters 41, 42, 43 rotate by a certain angle and stop down to cover almost half of the opening 65a. The ND filters 45, 46 geared with the driving pin 71 also rotate, and their rotational angle may be different from that of the lens shutters 41, 42, 43. Thus, the exposure of the ND filters 45, 46 may be changed according to the stop-down portion of the opening 65a. Therefore, although depending on the cam slits 45b, 46b of the ND filters 45, 46, the rotational angle may be controlled according to the design of the cam slits 45b, 46b.

When the rotor 70 rotates further, the opening 65a is completed stopped-down (or covered) by the lens shutters 41, 42, 43, as shown in FIG. 8B. In FIG. 8B, the lens shutters 41, 42, 43 are partially overlapped with each other and stop down the opening 65a. At first, the lens shutters 41, 42, 43 are partially overlapped with each other until they reach the center of the aperture 65a. As the driving pin 71 of the rotor 70 rotates, its interlocked cam slits 41b 42b, 43b also rotate, and as a result, the lens shutters 41, 42, 43 are rotated as well. In an exemplary embodiment, the cam slits 41b, 42b, 43b are all linear. Therefore, to gradually change the percentage of openness of the aperture 65a, or to gradually control the f number of incident light, the unit rotational angle of the rotor 70 is nonlinearly controlled. The ND filters 45, 46 interlocked to the driving pin 71 rotate together, and share a motion trajectory of the lens filters 41, 42. The cam slits 45b, 46b of the ND filters 45, 46 are linear. Therefore if the opening 65a goes from the completely opened state (FIG. 4) to the completely closed state (FIG. 8B), the stop-down portion of the opening 65a by the ND filters 45, 46 keeps changing. Preferably, the stop-down portion is proportional to the stop-down portion by the opening 65a. As varying the exposed area of the ND filters 45, 46 according to the decrement of the amount of incident light, it becomes possible to prevent deterioration of resolution caused by diffraction. The variable exposure degree and rotational angles of the ND filters 45, 46 may be controlled by properly designing the position and shape of the cam slit 45a.

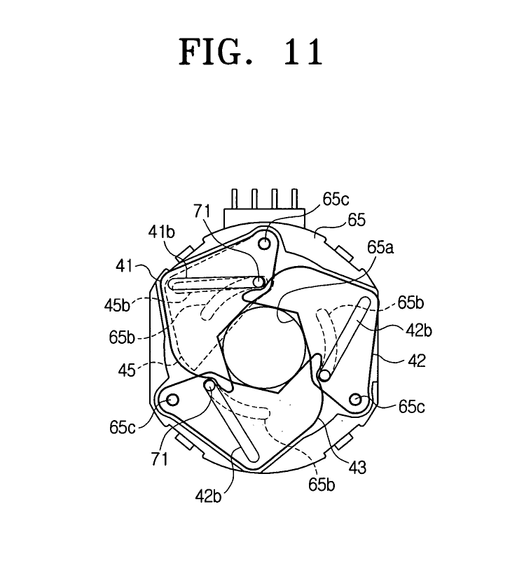

According to another exemplary embodiment shown in FIG. 9, the shutters 141, 142, 143 respectively have cam slits 141b, 142b, 143b, in which each cam slit has a non-linear part. As shown in FIG. 10, when the driving pin 71 moves by a fixed unit angle, the cam slit 141b is formed in a designated shape (that is obtained through experiments) to reach a certain f number (f. no). Therefore, the f number (f. no) may be controlled to a predetermined size by rotating the rotor 70 by a fixed angle. Since the rotor 70 rotates by a fixed unit angle, it is possible to differentiate rotational angles of the lens shutters 141, 142, 143 and control of opening the opening 65a is much easier.

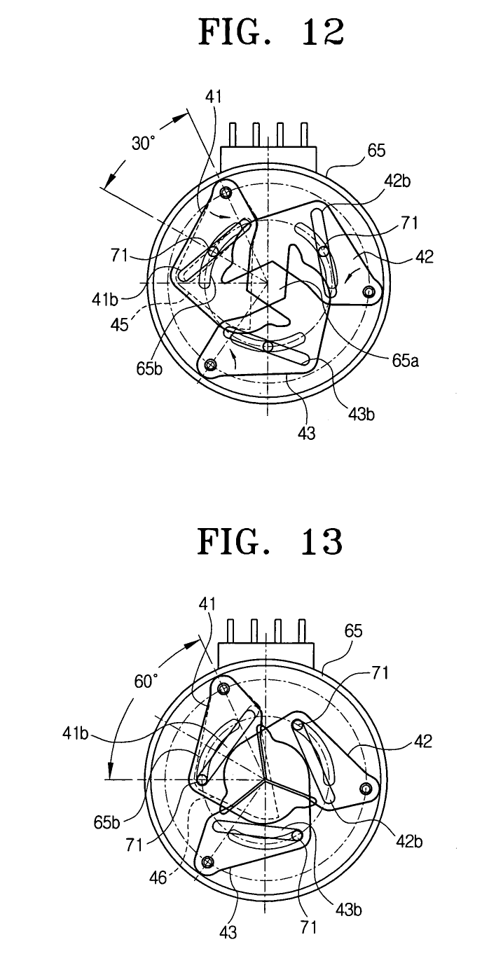

Additionally, as shown in FIGS. 11 to 13, one single ND filter 45 may be used. The ND filter 45 is rotatably installed by means of the driving pin 71. The ND filter 45 has the same center of rotation with one of the lens filters (e.g., the lens filter 41), and the ND filter 45 and the lens filter 41 move together almost at the same time by help of to the driving pin 71.

As shown in FIG. 12, unlike using two ND filters 45, 46 (FIG. 8a), a smaller amount of incident light passes through the opening 65a, given that the aperture size of the opening 65a is the same. Of course, in the case of using one single ND filter 45, the amount of incident light continuously changes depending on how much of the opening 65a is stopped-down by the lens shutters 41, 42, 43.

As described above, one or a plurality of the ND filters 45 may be used, as long as the ND filter(s) is installed to overlap the lens shutters 41, 42, 43. Thus, installation of the ND filter 45 becomes much easier, and an extra driving source for driving an additional ND filter 46 is not required. That is, one driving source is sufficient to drive a plurality of lens shutters 41, 42, 43 and a plurality of ND filters 45, 46, individually.

By installing more than one ND filter and differentiating the shape of the cam slits engaged with the driving pins 71, it is possible to more effectively control the amount of incident light passing through the aperture 65a, and thereby improve the resolution of images.

Also, by fitting a stepping motor inside the lens barrel, it is possible to control the lens shutters and the ND filters to move independently from each other.

Depending on how much of the light path is opened, the ND filter(s) moves independently from the lens shutters, and this makes it possible to more precisely control the amount of incident light. The present invention is capable of preventing a deterioration of light transmittance at low brightness, and prevents deterioration of the resolution caused by diffraction.

The foregoing embodiment and advantages are merely exemplary and are not to be construed as limiting the present invention. The present teaching may be readily applied to other types of apparatuses. Also, the description of the embodiments of the present invention is intended to be illustrative, and not to limit the scope of the claims, and many alternatives, modifications, and variations will be apparent to those skilled in the art.

1. An iris diaphragm of image photographing equipment, comprising:
at least one lens shutter disposed in a light path to adjust the amount of incident light by opening and closing the light path according to movement thereof; and
at least one ND filter independently movable with respect to the lens shutter to reduce the amount of incident light according to movement thereof in the light path that is opened by the lens shutter.

2. The iris diaphragm according to claim 1, wherein
the at least one lens shutter and the at least one ND filter are pivotally movable in the light path, respectively.

3. The iris diaphragm according to claim 2, wherein
the at least one lens shutter and the at least one ND filter have a common center of rotation.

4. The iris diaphragm according to claim 1, wherein
a stop-down portion of the light path by the at least one ND filter is varied according to movement of the at least one ND filter.

5. The iris diaphragm according to claim 4, wherein
the stop-down portion is inversely proportional to the openness of the light path.

6. The iris diaphragm according to claim 1, wherein
each of a plurality of ND filters have different light transmittances.

7. The iris diaphragm according to claim 1, wherein
each of a plurality of ND filters move independently of each other.

8. The iris diaphragm according to claim 1, wherein
an overlapped portion between the at least one ND filter and the at least one lens shutter is varied according to movement of the at least one ND filter.

9. The iris diaphragm according to claim 1, wherein
the at least one ND filter has a cam slit for pivoting movement.

10. The iris diaphragm according to claim 9, wherein
the cam slit has a substantially linear shape.

11. The iris diaphragm according to claim 9, wherein
the at least one lens shutter has a cam slit for pivoting movement.

12. The iris diaphragm according to claim 11, wherein
the cam slit of the at least one lens shutter and the cam slit of the at least one ND filter are overlapped with each other.

13. The iris diaphragm according to claim 12, wherein
the overlapped portion between the cam slits is inversely proportional to the openness of the light path.

14. An iris diaphragm driving device for image photographing equipment, comprising:
at least one lens shutter to open and close a light path;
at least one ND filter movable independently of the at least one lens shutter to reduce the amount of incident light passing through the light path; and
a driving unit to drive the at least one lens shutter and the at least one ND filter.

15. The iris diaphragm driving device according to claim 14, wherein
a motor housing supports the ND filter and provides the light path;
a stator assembly is installed inside the motor housing; and
a rotor is rotatably installed in the stator assembly to pivot the at least one ND filter with the rotation of the rotor.

16. The iris diaphragm driving device according to claim 15, wherein
the at least one ND filter is pivotally movable in the motor housing and is positioned in the light path according to the pivoting movement of the at least one ND filter.

17. The iris diaphragm driving device according to claim 15, wherein
the rotor has a driving pin to transfer the movement of the rotor to the pivoting movement of the at least one ND filter.

18. The iris diaphragm driving device according to claim 17, wherein
an axis boss on the motor housing supports the at least one ND filter to pivot thereon; and
a guide guides the motion of the driving pin.

19. The iris diaphragm driving device according to claim 17, wherein
the at least one ND filter has a cam slit that is shaped to engage the driving pin.

20. The iris diaphragm driving device according to claim 19, wherein
the cam slit has a substantially linear shape.

21. The iris diaphragm driving device according to claim 16, wherein
the at least one lens shutter is supported by the motor housing so that the at least one lens shutter and the at least one ND filter share the common center of rotation.

22. The iris diaphragm driving device according to claim 21, wherein
a driving pin transfers the movement of the rotor to the pivoting movement of the at least one ND filter.

23. The iris diaphragm driving device according to claim 22, wherein
the at least one ND filter and the at least one lens shutter has an axis hole supported by the motor housing, and a cam slit interoperable by the driving pin.

24. The iris diaphragm driving device according to claim 23, wherein
the cam slit of the at least one ND filter and the cam slit of the at least one lens shutter have different shapes.

25. The iris diaphragm driving device according to claim 23, wherein
the cam slit of the at least one ND filter and the cam slit of the at least one lens are partially overlapped according to the pivoting movement of the at least one ND filter and the at least one lens shutter.

26. The iris diaphragm driving device according to claim 14, wherein
the device has a plurality of lens shutters and a plurality of ND filters.

27. A camera unit, comprising:
a lens barrel;
a zoom lens module housed in the lens barrel;
a focusing lens module housed in the lens barrel;
at least one lens shutter movably installed between the zoom lens module and the focusing lens module to adjust an aperture that light passes through in response to movement of the zoom lens module and the focusing lens module;
an ND filter movably installed inside the lens barrel to reduce the amount of incident light by covering the aperture that is stopped down by the at least one lens shutter; and
a driving unit installed inside the lens barrel to drive the at least one lens shutter and the ND filter.

28. The camera unit according to claim 27, wherein
a motor housing is installed in the lens barrel to support the pivoting movement of the at least one lens shutter and the ND filter;
a stator assembly is installed in the motor housing; and
a rotor is rotatably installed in the stator assembly to pivot the at least one lens shutter and the ND filter according to rotation of the rotor.

29. The camera unit according to claim 28, wherein
the at least one lens shutter and the ND filter are pivoted together on the same axis.

30. The camera unit according to claim 28, wherein
the rotor has at least one driving pin to interoperate with the at least one lens shutter and the ND filter.

31. The camera unit according to claim 30, wherein
the at least one lens shutter and the ND filter each have an axis hole as the center of rotation; and a cam slit interoperable by the driving pin.

32. A method of controlling an iris diaphragm, the method comprising the steps of
moving at least one lens shutter to stop down an aperture that incident light passes through; and
moving at least one ND filter to cover the stop-down aperture to reduce the amount of incident light, wherein the decrement of incident light is fixed or varied according to a change of the aperture size.

33. The method according to claim 32, further comprising
moving the at least one lens shutter and moving the at least one ND filter at the same time.

34. The method according to claim 32, further comprising
moving the at least one lens shutter to reduce the amount of incident light and moving the at least one ND filter to increase the decrement of incident light in an amount inversely proportional to the amount of incident light reduced by moving the at least one lens shutter.

35. The method according to claim 32, further comprising
varying the amount of incident light with the at least one lens shutter in an amount inversely proportional to the decrement of incident light with the at least one ND filter.
